(19) United States
(12) Patent Application Publication
(10) Pub. No.: US 2018/0159124 A1
(43) Pub. Date: Jun. 7, 2018

(54) NEGATIVE ELECTRODE ACTIVE MATERIAL FOR LITHIUM ION SECONDARY BATTERIES, AND LITHIUM ION SECONDARY BATTERY

(71) Applicant: HITACHI, LTD., Tokyo (JP)

(72) Inventor: Makoto OKAI, Tokyo (JP)

(73) Assignee: HITACHI, LTD., Tokyo (JP)

(21) Appl. No.: 15/578,538

(22) PCT Filed: May 25, 2016
(86) PCT No.: PCT/JP2016/065372

§ 371 Date: Nov. 30, 2017

(30) Foreign Application Priority Data
Jun. 22, 2015 (JP) 2015-124352

(51) Int. Cl. H01M 4/38; H01M 10/0525; H01M 4/36; H01M 4/587; H01M 4/134

(52) U.S. Cl. CPC H01M 4/386; H01M 10/0525; H01M 2004/027; H01M 4/587; H01M 4/134; H01M 4/366

(57) ABSTRACT

The objective of the present invention is to provide a negative electrode active material for lithium ion secondary batteries, which has high capacity and a long service life by solving the aforementioned problem. A negative electrode active material for lithium ion secondary batteries, which comprises scale-like silicon particles, and wherein the surface of each scale-like silicon particle is covered with a carbon layer.

### TECHNICAL FIELD

The present invention relates to a negative electrode active material for lithium ion secondary batteries, and to lithium ion secondary batteries.

### BACKGROUND ART

Graphite-based carbon materials are widely used as negative electrode active materials for lithium ion secondary batteries. The stoichiometric composition of graphite charged with lithium ions is LiC₆, and the theoretical capacity can be calculated as 372 mAh/g.

The stoichiometric composition of silicon charged with lithium ions is Li₁₅Si₄ or Li₂₂Si₅, and the theoretical capacity can be calculated as 3,577 mAh/g or 4,197 mAh/g. As these figures indicate, silicon is an attractive material with a lithium storage capability 9.6 times or 11.3 times that of graphite. However, when charged with lithium ions, silicon particles undergo an about 2.7- to 3.1-time volume expansion, and become mechanically destroyed as the lithium ions are repeatedly charged and discharged. Fine silicon particles from these destroyed silicon particles become electrically isolated, and a new electrochemical coating occurs on the destroyed surface. This increases the irreversible capacity, and the charge-discharge cycle characteristic seriously deteriorates.

Such mechanical destruction due to charging and discharging of lithium ions can be prevented by using nano-sized silicon particles as the negative electrode active material of a lithium ion secondary battery. However, some of the silicon nanoparticles become electrically isolated as a result of volume changes due to charging and discharging of lithium ions, and this seriously deteriorates the service life characteristic.

PTL 1 describes an example in which a Si metallic thin film produced by sputtering is pulverized, and used as a negative electrode for lithium ion secondary batteries.

### CITATION LIST

### Patent Literature

PTL 1: JP-A-2011-65983

### SUMMARY OF INVENTION

### Technical Problem

However, scale-like Si particles of a pulverized Si metallic thin film easily make contact on their surfaces, and form clumps. Because Si-based active materials have lower conductance than carbon materials, only small spaces are created between particles in the clumps of scale-like Si active material, and the conductivity decreases.

It is accordingly an object of the present invention to find a solution to these problems, and provide a high-capacity and long-life negative electrode active material for lithium ion secondary batteries.

### Solution to Problem

The present invention solves the foregoing problems with, for example, the following features.

A negative electrode active material for use in lithium ion secondary batteries and comprising scale-like silicon particles,

wherein the scale-like silicon particles are surface-coated with a carbon layer.

The negative electrode has a collector with the negative electrode mixture applied to the collector. The scale-like silicon particles overlap on the collector, and are electrically connected to each other via the carbon layer.

### Advantageous Effects of Invention

The present invention enables producing a highly conductive mixture layer even with scale-like silicon particles, and providing a high-capacity and long-life negative electrode active material for lithium ion secondary batteries.

### BRIEF DESCRIPTION OF DRAWINGS

FIG. 1 is a diagram schematically representing a negative electrode active material for lithium ion secondary batteries according to an embodiment of the present invention.

FIG. 2 shows an electron scanning micrograph of a negative electrode active material for lithium ion secondary batteries according to an embodiment of the present invention.

FIG. 3 shows an electron scanning micrograph of the negative electrode active material for lithium ion secondary batteries according to the embodiment of the present invention.

FIG. 4 shows an electron scanning micrograph of a negative electrode active material for lithium ion secondary batteries according to an embodiment of the present invention.

FIG. 5 shows an electron scanning micrograph of the negative electrode active material for lithium ion secondary batteries according to the embodiment of the present invention.

FIG. 6 is a block diagram of a device representing a method for producing a negative electrode active material for lithium ion secondary batteries according to an embodiment of the present invention.

FIG. 7 represents the result of calculations of the dependence of electrical capacity on silicon weight ratio according to an embodiment of the present invention.

FIG. 8 is a schematic view of a lithium ion secondary battery according to an embodiment of the present invention.

FIG. 9 represents the service life characteristic of a lithium ion secondary battery according to an embodiment of the present invention.

### DESCRIPTION OF EMBODIMENTS

The following specifically describes an embodiment of the present invention with reference to the accompanying drawings. The following detailed explanation serves to illustrate or describe specific examples of the substance of the present invention, and does not limit the invention in any ways. Various changes and modifications may be appropriately made by a skilled person without departing from the technical idea disclosed herein.

### Example 1

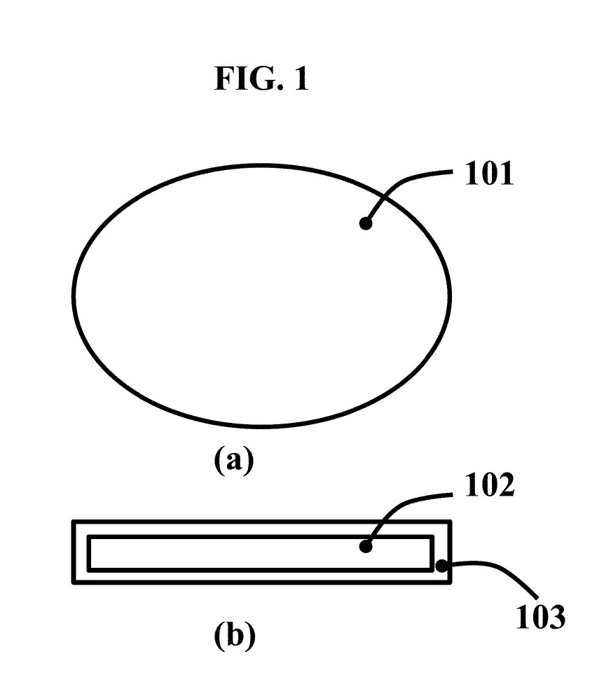

First Example of the present invention is described below with reference to FIGS. 1 to 7.

### <Negative Electrode Active Material>

FIG. 1 is a diagram schematically representing a negative electrode active material for lithium ion secondary batteries according to an embodiment of the present invention. The figure shows (a) a top view, and (b) a sectional side view. A carbon-coated scale-like silicon particle 101 has a structure with a carbon layer 103 coated over the surface of a scale-like silicon particle 102. The scale-like silicon particle has a thickness of 5 to 100 nm, desirably 10 to 50 nm. The longest axis of the flat portion, or the major axis, is 100 nm to 3 μm, desirably 100 nm to 1 μm. When the thickness of the scale-like silicon particle is 5 nm or less, the mechanical strength will be weak, and there is a possibility of the particle being shattered during the production of a negative electrode paste. The thickness is desirably 10 nm or more to provide sufficient mechanical strength. When the thickness is 100 nm or more, the particle has a high possibility of being destroyed by the volume expansion that occurs when charging lithium ions. The thickness is desirably 50 nm or less to prevent destruction even during high-speed charging and discharging. The particle shape cannot be described as a scale shape when the major axis is 100 nm or less. With a major axis of 3 μm or more, the particle has a high possibility of being destroyed by the volume expansion that occurs while charging lithium ions. The major axis is desirably 1 μm or less to prevent destruction even during high-speed charging and discharging.

The scale-like silicon particle 101 may be Si, SiO₂, or an alloy of Si and other metals, for example, such as Ti, Cu, and Al, provided that a Si element is contained.

When the scale-like silicon particles are used as a negative electrode material to produce a negative electrode mixture, the scale-like silicon particles tend to clump under the Van der Waals' forces because of their flat shape. However, the carbon layer 103 on the scale-like silicon particles can provide conductivity between the particles.

The scale-like silicon particles can be produced by pulverizing a Si metallic thin film formed on a substrate by, for example, sputtering. Preferably, the scale-like silicon particles are subsequently processed to provide the desired thickness and the desired major axis using a planetary ball mill or a bead mill. The desired thickness and the desired major axis can be achieved by mixing the scale-like silicon particles with a ball mill. The scale-like silicon particles are also separated from each other with this process.

The carbon layer 103 is electrically conductive, and has the effect to improve the electrical conduction between the scale-like silicon particles 102. A certain effect can still be obtained when the surface of the scale-like silicon particle 102 is partially coated with the carbon layer 103, instead of being fully coated. The surface of the scale-like silicon particle undergoes oxidation in the atmosphere, and the particle is coated with a natural oxide film having a thickness of about 2 nm. The carbon layer 103 may be formed on the natural oxide film, or may be directly formed on the silicon surface after removing the natural oxide film. From a standpoint of reducing electrical resistance, it is desirable to remove the natural oxide film. The natural oxide film can be removed by, for example, conducting a heat treatment at 1,000° C. in a hydrogen atmosphere.

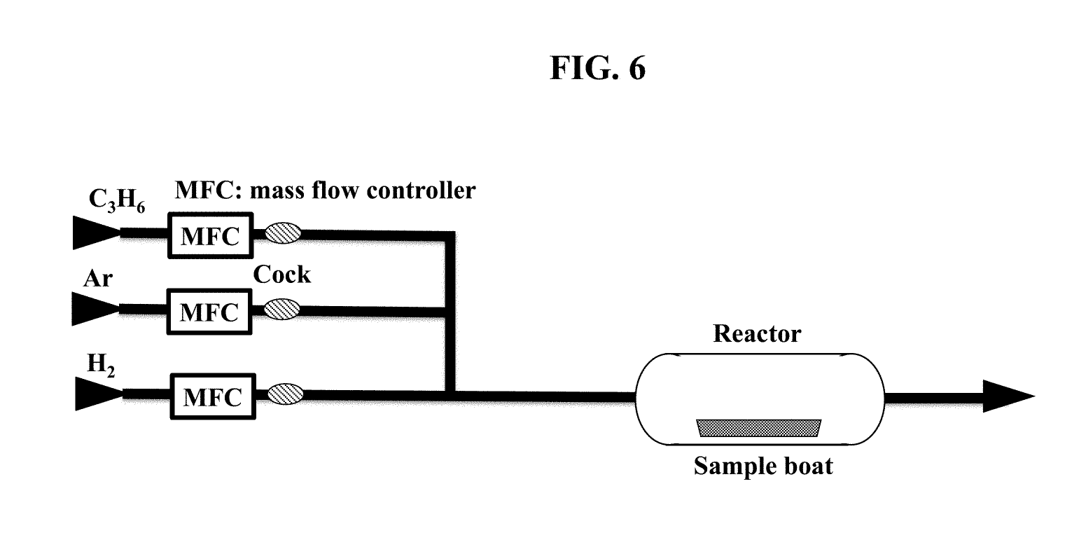

A method for producing the carbon layer 103 is described below with reference to FIG. 6. Scale-like silicon particles are placed in a sample boat, and installed near the center of a reaction furnace. The reaction furnace is made out of quartz, and has a diameter of 5 cm, and a length of 40 cm. Using the hydrogen line shown in FIG. 6, hydrogen gas is passed at a flow rate of 200 mL/min. A growth furnace was heated from room temperature to 1,000° C. at a rate of 10° C./min, and the temperature was maintained at 1,000° C. for 1 hour. The natural oxide film formed on the surface of the scale-like silicon particle can be reduced by this heat treatment. After closing the hydrogen line, argon gas was passed at a flow rate of 200 mL/min, and the temperature was lowered to 800° C. at a rate of 10° C./min. Upon the temperature reaching 800° C., propylene gas was introduced at a flow rate of 10 mL/min, and, at the same time, the flow rate of argon gas was adjusted to 190 mL/min to grow a carbon coating for 1 hour. Thereafter, the propylene gas line was closed, and argon gas was passed at a flow rate of 200 mL/min. After 15 minutes, the silicon particles were naturally cooled. In this way, a carbon layer (5 nm thickness) having a multilayer structure of nanographene can be formed on the surface of the scale-like silicon particles. The carbon layer is a multilayer of laminated nanographene layers, and has excellent conductivity itself. The carbon layer also improves the electron mobility between the scale-like silicon particles.

The hydrogen treatment is not required when not removing the natural oxide film on the surface of the scale-like silicon particle. The carbon layer may have any adjusted thickness in a range of 2 to 100 nm. When the thickness is 2 nm or less, the mechanical strength will be weak, and detachment may occur under the stress of slurry production. With a thickness of 100 nm or more, it becomes difficult to coat the scale-like silicon particle in a uniform thickness. The carbon layer has a multilayer structure of laminated nanographene layers, and has an electrical conductivity of 1,000 S/m or more.

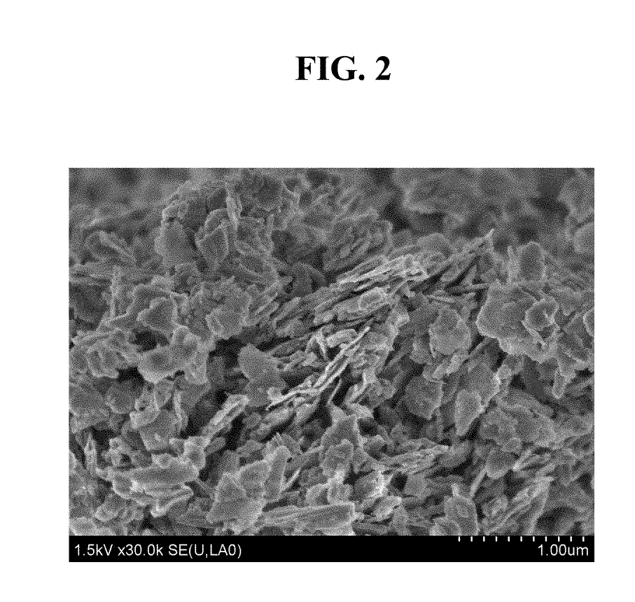

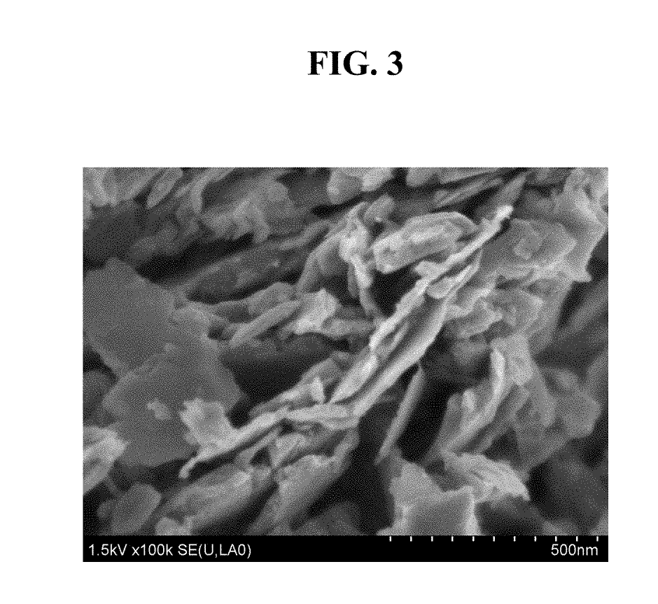

FIGS. 2 and 3 show electron scanning micrographs of scale-like silicon particles. As can be seen in the low-magnification image shown in FIG. 2, the mean value of the major axis, which is the longest axis of the flat portion of the scale-like silicon particle, is about 300 nm. From the high-magnification image shown in FIG. 3, it can be seen that the thickness of the scale-like silicon particle is about 20 nm.

The scale-like silicon particle becomes almost fully coated with the method shown in FIG. 6. Here, the scale-like silicon particle may have a coating ratio of 90% or more. With a high coating ratio, conductivity can be ensured even when there is an overlap of scale-like silicon particles. A method is available that provides carbon by mixing conductive carbon with scale-like silicon particles. In this case, the coating ratio will not be as high as that achievable with the method above. However, by mixing, for example, a bead mill in the mixing step, the scale-like silicon particles can be made loose, and the carbon can enter the space between the particles to improve the conductivity between the silicon particles.

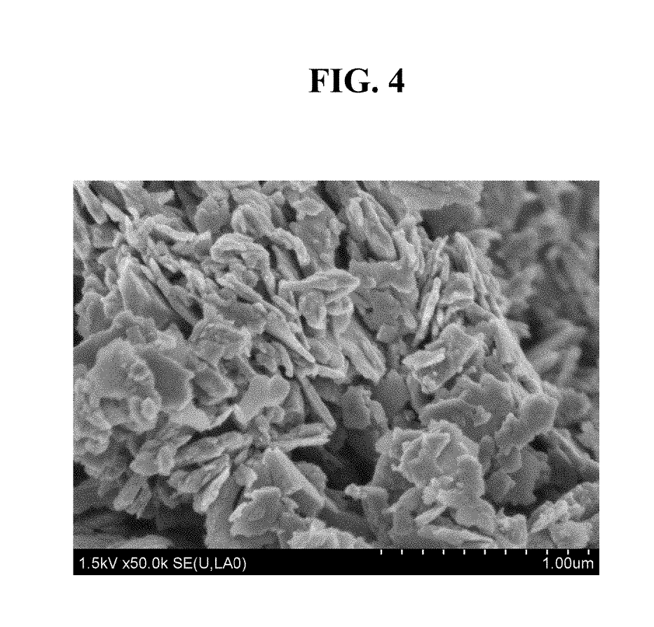

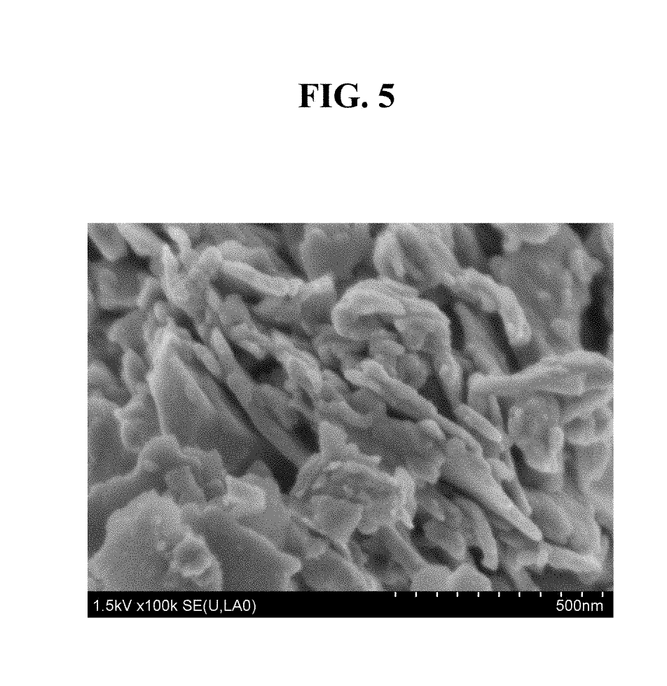

FIGS. 4 and 5 show electron scanning micrographs of scale-like silicon particles coated with a carbon layer. FIG. 4 shows a low-magnification image. FIG. 5 shows a high-magnification image. It can be seen in the high-magnification image shown in FIG. 5 that the thickness has increased to about 40 nm. This is believed to be due to the carbon layer of about 10-nm thickness uniformly coating the surface of the scale-like silicon particle. An analysis by a combustion method revealed that the carbon weight ratio was 9.9 wt %, and the silicon weight ratio was 90.1 wt %.

The electrical capacity can be adjusted by adjusting the amount of carbon coating on the scale-like silicon surface.

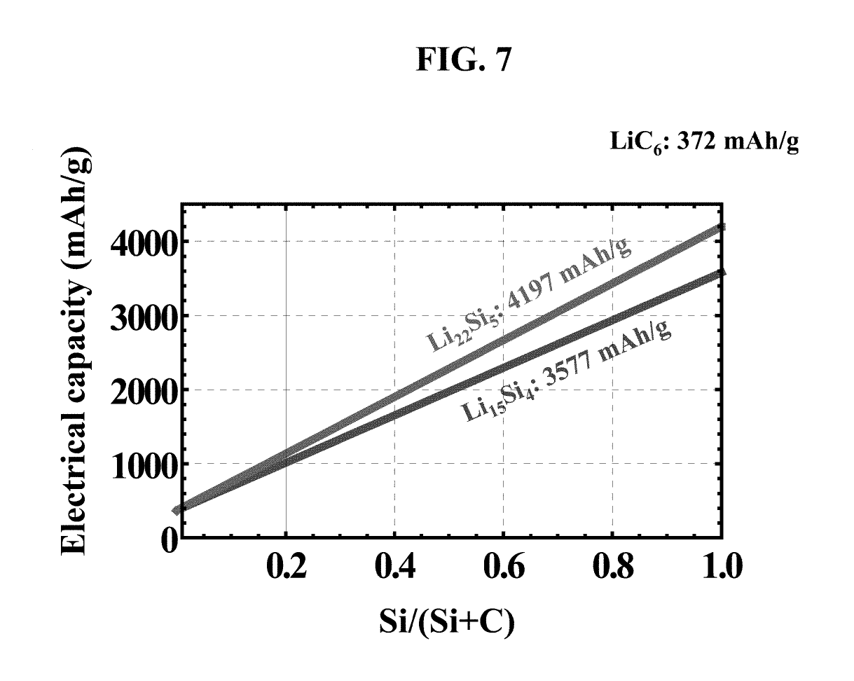

FIG. 7 represents the result of calculations of the dependence of electrical capacity on silicon weight ratio. The stoichiometric composition of carbon charged with lithium ions was assumed to be LiC₆, and calculations were performed by assuming that the electrical capacity was 372 mAh/g. For silicon, calculations were performed by assuming that the stoichiometric composition with the charged lithium ions was Li₁₅Si₄, and the electrical capacity was 3,577 mAh/g, and that the stoichiometric composition with the charged lithium ions was Li₂₂Si₅, and the electrical capacity was 4,197 mAh/g. On the horizontal axis, Si in Si/(Si+C) represents the weight of the scale-like silicon particles, and C represents the weight of the carbon layer and other components. By varying the silicon weight ratio, the electrical capacity can be controlled over a wide range of spectrum from the electrical capacity that is characteristic of carbon to the electrical capacity that is characteristic of silicon. In actual practice, a composite material containing 5 to 95 wt % of silicon can be produced.

In this Example, scale-like silicon particles 101 were produced that had an average thickness of 40 nm, and an average major axis of 300 nm. Subsequently, the natural oxide layer on the surface of the scale-like silicon particles was removed, and a carbon layer having a thickness of 5 nm was directly coated on the scale-like silicon particles 101 using the method represented in FIG. 6. The final silicon weight ratio was 90.1 wt %.

### (Battery Production)

A battery was produced using the negative electrode active material, and evaluated.

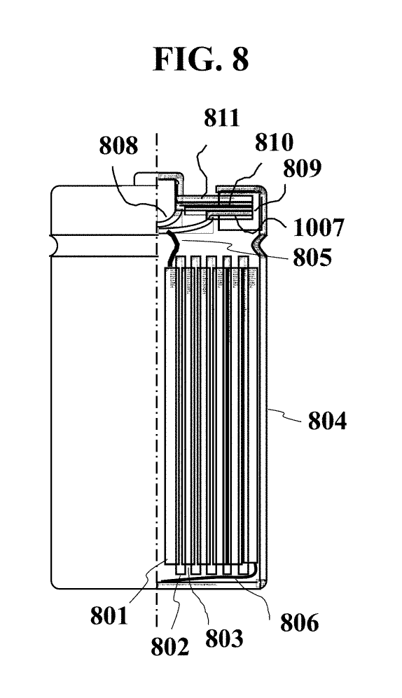

Second Example of the present invention is described below with reference to FIG. 8. FIG. 8 shows a positive electrode 801, a separator 802, a negative electrode 803, a battery canister 804, a positive electrode collector tab 805, a negative electrode collector tab 806, an inner lid 807, an inner pressure release valve 808, a gasket 809, a positive temperature coefficient (TPC; positive temperature coefficient) resistive element 810, and a battery lid 811. The battery lid 811 is an integrated component that includes the inner lid 807, the inner pressure release valve 808, the gasket 809, and the positive temperature coefficient resistive element 810.

As an example, the positive electrode 801 can be produced using the following procedure. LiMn₂O₄ is used as the positive electrode active material.

A graphite powder (7.0 wt %) and acetylene black (2.0 wt %) are added as conductive materials to 85.0 wt % of the positive electrode active material. To the mixture is then added 6.0 wt % of binder polyvinylidene fluoride (hereinafter, simply “PVDF”; dissolved in 1-methyl-2-pyrrolidone (hereinafter, simply “NMP”). These are mixed using a planetary mixer, and bubbles in the slurry are removed in a vacuum to prepare a homogeneous positive electrode mixture slurry. The slurry is then evenly and uniformly applied to the both surfaces of a 20 μm-thick aluminum foil using an applicator. After application, the whole is compression molded with a roller press machine to make the electrode density 2.55 g/cm³. The molded product is then cut into a positive electrode 801 measuring 100 μm in thickness, 900 mm in length, and 54 mm in width, using a cutting machine.

As an example, the negative electrode 803 can be produced using the following procedure. The carbon-coated scale-like silicon particles described above can be used as the negative electrode active material. A binder PVDF (5.0 wt %; dissolved in NMP) is added to 95.0 wt % of the negative electrode active material. These are mixed using a planetary mixer, and the bubbles in the slurry are removed in a vacuum to prepare a homogeneous negative electrode mixture slurry. The slurry is then evenly and uniformly applied to the both surfaces of a 10 μm-thick rolled copper foil using an applicator. After application, the whole is compression molded with a roller press machine to make the electrode density 1.3 g/cm³. The molded product is then cut into a negative electrode 803 measuring 110 μm in thickness, 950 mm in length, and 56 mm in width, using a cutting machine. The negative electrode has a structure with the negative electrode mixture applied to the collector, and the scale-like silicon particles exist by overlapping on the collector, and are electrically connected to each other via the carbon layer. In this way, conductivity can be provided even for materials, such as the scale-like silicon particles, having a high surface contacting property.

Other negative electrode active materials may be used for the negative electrode mixture. For example, a carbon-based active material, such as graphite, may be mixed, in addition to the carbon-coated scale-like silicon particles.

The positive electrode collector tab 805, and the negative electrode collector tab 806 are ultrasonically welded to the positive electrode 801, and the uncoated portion (collector plate exposed surface) of the negative electrode 803, respectively, which may be produced in the manner described above. The positive electrode collector tab 805 may be an aluminum reed, and the negative electrode collector tab 806 may be a nickel reed.

Thereafter, a separator 802 made of a 30 μm-thick porous polyethylene film is inserted in the positive electrode 801 and the negative electrode 803. The positive electrode 801, the separator 802, and the negative electrode 803 are then wound. The wound unit is housed in the battery canister 804, and the negative electrode collector tab 806 is connected to the bottom of the battery canister 804 using a resistive welding machine. The positive electrode collector tab 805 is ultrasonically welded to the bottom surface of the inner lid 807.

A nonaqueous electrolytic solution is injected before attaching the battery lid 811 to the battery canister 804. The solvent of the electrolytic solution is, for example, a mixture of ethylene carbonate (EC), dimethyl carbonate (DMC), and diethyl carbonate (DEC). These may be mixed in a volume ratio of 1:1:1. The electrolyte is 1 mol/L (about 0.8 mol/kg) of LiPF₆. The electrolytic solution is dropped over the wound unit, and the battery lid 811 is swaged to the battery canister 804 to obtain a lithium ion secondary battery.

### <Battery Evaluation Method>

Measurements of discharge capacity and percentage remaining capacity were performed in a constant current mode at a rate of 1 C.

### Comparative Example 1

For comparison, the service life characteristic of a battery using scale-like silicon particles with no carbon coating as the negative electrode material was also examined. Other conditions, including the evaluation method, are the same as in Example 1.

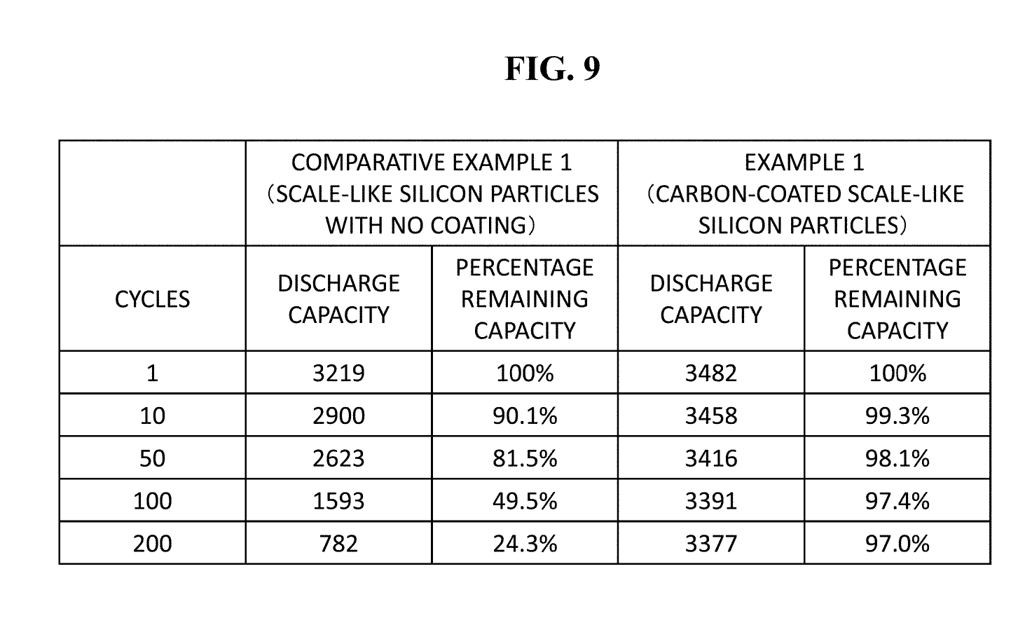

FIG. 9 represents the service life characteristic of the battery produced with the negative electrode material of the present invention. In Example 1, the percentage remaining capacity after 200 cycles was 97.0%, whereas the scale-like silicon particles with no carbon coating had a percentage remaining capacity of 24.3%.

As demonstrated above, the negative electrode material of the present invention was shown to have an excellent high-capacity and long-service-life characteristic.

### REFERENCE SIGNS LIST

101 Carbon-coated scale-like silicon particle
102 Scale-like silicon particle
103 Carbon layer
801 Positive electrode
802 Separator
803 Negative electrode
804 Battery canister
805 Positive electrode collector tab
806 Negative electrode collector tab
807 Inner lid
808 Pressure release valve
809 Gasket
810 Positive temperature coefficient resistive element
811 Battery lid

1. A negative electrode active material for lithium ion secondary batteries and comprising scale-like silicon particles,
wherein the scale-like silicon particles are surface-coated with a carbon layer
wherein the carbon layer is a multilayer nanographene layer with laminated layers of nanographene.

2. (canceled)

3. The negative electrode active material for lithium ion secondary batteries according to 1, wherein the scale-like silicon particles have a thickness in a range of 5 to 100 nm.

4. The negative electrode active material for lithium ion secondary batteries according to claim 3, wherein the scale-like silicon particles have a length of 100 nm to 3 μm as measured as the longest axis of a flat portion.

5. The negative electrode active material for lithium ion secondary batteries according to claim 4, wherein the silicon has a weight ratio of 5 to 95 wt % with respect to a total amount of the scale-like silicon particles and the carbon layer.

6. The negative electrode active material for lithium ion secondary batteries according to claim 5, wherein the carbon layer has an electrical conductivity of 1,000 S/m or more.

7. A lithium ion secondary battery comprising a positive electrode and a negative electrode,
wherein the negative electrode includes a negative electrode mixture, and the negative electrode mixture includes the negative electrode active material for lithium ion secondary batteries of any one of claim 1.

8. The lithium ion secondary battery according to claim 7,
wherein the negative electrode has a collector with the negative electrode mixture applied to the collector, and
wherein the scale-like silicon particles overlap on the collector, and are electrically connected to each other via the carbon layer.
